(19) United States
(12) Patent Application Publication
(10) Pub. No.: US 2026/0004427 A1
(43) Pub. Date: Jan. 1, 2026

(54) ERROR STATE VALIDATION OF A MEDIA TRANSMISSION SYSTEM

(71) Applicant: Google LLC, Mountain View, CA (US)

(72) Inventor: Erik Lars Wilhelm Språng, Enskededalen (SE)

(21) Appl. No.: 18/759,549

(22) Filed: Jun. 28, 2024

(51) Int. Cl. G06T 7/11; G06T 7/136; G06T 7/174; H04N 7/15

(52) U.S. Cl. CPC G06T 7/11; G06T 7/136; G06T 7/174; H04N 7/15

(57) ABSTRACT

A method and systems are disclosed for error state validation of a video transmission system. Image data including one or more image frames is identified by a client device. Two or more regions of the one or more image frames are determined for error sampling. Error sampling data is derived based on the image data, the error sampling data indicating characteristics of one or more image pixels located at the two or more regions. One or more encoding operations are performed to encode the image data. The encoded image data and the error sampling data is transmitted to an additional client device.

### TECHNICAL FIELD

Aspects and implementations of the present disclosure relate to error state validation of a video transmission system.

### BACKGROUND

A platform can enable users to connect with other users through a video-based or audio-based virtual meeting (e.g., a conference call). The platform can provide tools that allow multiple client devices to connect over a network and share each other's audio data (e.g., a voice of a user recorded via a microphone of a client device) and/or video data (e.g., a video captured by a camera of a client device, etc.) for efficient communication. In some instances, errors (e.g., encoding errors, decoding errors, etc.) can occur during the transmission of audio data and/or video data between client devices. It can be difficult for the platform to detect such errors and/or a source of such errors.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying, by a client device, image data including one or more image frames. The method further includes determining, by the client device, two or more regions of the one or more image frames for error sampling. The method further includes deriving, by the client device and based on the image data, error sampling data indicating characteristics of one or more image pixels located at each of the two or more regions. The method further includes performing, by the client device, one or more encoding operations to encode the image data. The method further includes transmitting, by the client device, the encoded image data and the error sampling data to an additional client device.

In some implementations, determining the plurality of regions for error sampling includes obtaining one or more outputs of a random image pixel selector function. The one or more outputs comprising two or more randomly selected image pixels of the one or more image frames. The method further includes identifying, for each of the two or more randomly selected image pixels, a respective region of the one or more image frames that comprises the respective image pixel. The method further includes determining whether a distance between the respective region of the one or more image frames satisfies one or more sampling distance criteria with respect to another region of the two or more of regions.

In some implementations, determining whether the distance between the respective region of the one or more image frames satisfies one or more sampling distance criteria with respect to another region of the two or more of regions includes determining whether a distance between the respective region and another region of the two or more of regions exceeds a threshold distance, or determining that the one or more image pixels located at the respective region depicts at least one of a different object or a different scene from the at least one of the object or the scene depicted by the one or more image pixels located at the other region.

In some implementations, the characteristics of the one or more image pixels located at each of the two or more regions includes at least one of color data or light intensity data for a portion of an image depicted by the one or more image pixels.

In some implementations extracting the error sampling data includes determining the at least one of the color data or the light intensity data for a subpixel of each of the one or more image pixels located at a respective region of the two or more regions.

In some implementations, the encoded image data is transmitted to the additional client device via a first data channel and the error sampling data is transmitted to the additional client device via a second data channel.

In some implementations, the method further includes transmitting, to the additional client device, an indication of each of the two or more regions of the one or more image frames comprising image pixels for which error sampling data was extracted.

In some implementations, the one or more image frames depict a participant of a virtual meeting in an environment. The encoded image data and the error sampling data are transmitted to the additional client device during the virtual meeting.

In some implementations, the derived error sampling data further indicates characteristics of a set of image pixels surrounding each respective region of the two or more regions, wherein the set of image pixels surrounding each respective region of the two or more regions has at least one of a fixed size or a fixed dimension.

An aspect of the disclosure provides a system including a memory and a set of one or more processing devices coupled to the memory. The set of one or more processing devices is to perform operations including receiving, by a client device connected to a platform, a data stream from another client device connected to the platform. The data stream includes encoded image data associated with one or more image frames and error sampling data indicating first characteristics of one or more image pixels located at each of two or more regions of the one or more image frames. The operations further include performing, by the client device, one or more decoding operations to decode the encoded image data. The operations further include determining, by the client device, second characteristics of the one or more image pixels located at each of the two or more regions based on the decoded image data. The operations further include identifying, by the client device and based on the first characteristics and the second characteristics of the one or more image pixels, an indication of an error in the decoded image data. The operations further include transmitting, by the client device, a notification indicating the error in the decoded image data to the platform.

In some implementations, the characteristics of one or more image pixels located at each of a two or more regions of the one or more image frames includes at least one of color data or light intensity data for a portion of an image depicted by the one or more image pixels.

In some implementations, determining the second characteristics of the one or more image pixels located at each of the two or more regions based on the decoded image data includes determining the at least one of the color data or the light intensity data for a subpixel of each of the one or more image pixels located at a respective region of the two or more regions of the decoded image data.

In some implementations, a first portion of the data stream comprising the encoded image data is received via a first channel and a second portion of the data stream comprising the error sampling data is received via a second channel.

In some implementations, the operations further include receiving, from an additional client device that transmitted the data stream, an indication of each of the two or more regions of the one or more image frames comprising image pixels for which error sampling data was extracted.

In some implementations, the one or more image frames depict a participant of a virtual meeting in an environment, and wherein the data stream is received during the virtual meeting.

In some implementations, a distance between each of the two or more regions satisfies one or more sampling distance criteria.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform and an example error detection engine 162, in accordance with implementations of the present disclosure.

FIG. 3 depicts a flow diagram of an example method for error state validation of a media transmission system, in accordance with implementations of the present disclosure.

FIG. 4 depicts a flow diagram of another example method for error state validation of a media transmission system, in accordance with implementations of the present disclosure.

FIGS. 5A and 5B illustrate an example pixel map of an image frame, in accordance with implementations of the present disclosure.

FIG. 6 illustrates an example predictive system, in accordance with implementations of the present disclosure.

FIG. 7 is a block diagram illustrating an exemplary computer system, in accordance with implementations of the present disclosure.

### DETAILED DESCRIPTION OF THE DRAWINGS

Aspects of the present disclosure generally relate to error state validation of a video transmission system. A platform can enable users to connect with other users through a video-based or audio-based virtual meeting (e.g., a conference call). During a virtual meeting, the platform can facilitate the transmission of image data (e.g., image frames) depicting one or more virtual meeting participants between client devices of the virtual meeting participants. For example, a client device (e.g., connected to the platform) of a virtual meeting participant can capture image data of the participant, encode the captured data into data packets, and provide the encoded data packets to one or more other client devices (e.g., connected to the platform) associated with other participants of the virtual meeting. The receiving device(s) can arrange the encoded data packets in a sequential order (or an approximate sequential order), decode the encoded data packets, and provide the image data of the decoded data packets for presentation to the other virtual meeting participant(s).

Errors can occur at various points in the transmission pipeline, which can cause the image presented via the receiving client device to be distorted. Such distortion can be easily detected by a user (e.g., a human) consuming the image and/or audio, but is not detectable by the platform, unless reported by the user. Some systems calculate image quality metrics, such as peak signal-to-noise ratio (PSNR), structural similarity index (SSIM), video multimethod assessment fusion (VMAF), and so forth, to determine the quality of the image data fed to and output from the transmission pipeline. However, calculating such image quality metrics can consume a significant amount of computing resources (e.g., processing cycles, memory space, power resources, etc.) and may not be indicative of whether an image is distorted (e.g., in violation of a video streaming specification) or of poor quality (e.g., while in compliance with the video streaming specification). Further, calculating such metrics involves comparing the image data output from the transmission pipeline to a pristine version of the image data (e.g., including no or few errors), which may not be available for image data collected during a virtual meeting. In addition, calculation of such metrics may involve the assumption that the image and/or audio follows expectations from “natural image statistics,” which may not be applicable to situations that involve sharing of electronic documents over a video stream for a virtual meeting. Other error detection techniques involve artificial intelligence (AI) and/or machine learning models that are trained to predict a quality of image data at a receiving device in view of a human perception of the image data. Such techniques implement computationally heavy processes which can also consume a significant amount of computing resources.

In addition, some errors may only occur under particular circumstances. For example, an error may occur in the transmission of data packets via a network when a particular amount of the network bandwidth is being consumed (e.g., by transmission of audiovisual streams for the virtual meeting, for other processes, etc.). Such errors can include, in some instances, a loss (also referred to as “dropping” of data transmitted between devices and/or disorganization of the data packets transmitted between the devices. It can be difficult, and in some instances, impossible for a platform to recreate the circumstances surrounding the transmission of the data packets when the error occurred outside of the context of the virtual meeting. In another example, an encoder engine at a client device may introduce errors into the data stream when the data stream is encoded at a particular resolution. Even if this error is detected by the platform according to conventional techniques, it can be difficult for the platform, after the virtual meeting, to pinpoint the resolution of the data stream as the cause of the errors.

As indicated above, conventional systems are typically unable to detect distortion or other such quality issues, and the source of such issues may not be identified (e.g., by developers or operators of the platform). Even if the source of such distortion and/or other quality issues are identified, it can take a significant amount of time, and therefore computing resources (e.g., processing cycles, memory space, etc.) to correct or otherwise mitigate the distortion and/or quality issues. Accordingly, the distortion, as described above, can decrease an efficiency and efficacy, and increase a latency, of the overall system. Further, image and/or audio that is distorted and/or of poor quality can be distracting to a participant of the virtual meeting, which can impact the overall experience of the participant during the virtual meeting.

Implementations of the present disclosure address the above and other deficiencies by providing techniques for error state validation of a video transmission system. Prior to encoding image data for transmission to a receiving client device, a transmitting client device extracts error sampling data from one or more portions of the image data. For example, the transmitting client device can extract the error sampling data from one or more sets of pixels located at distinct regions of an image frame of the image data. The error sampling data can include characteristics (e.g., color data and/or intensity data) associated with a portion of a pixel (e.g., red portion, green portion, blue portion, etc.) at the distinct regions. The regions of the image frame selected for error sampling can be selected randomly or pseudo randomly. For example, the regions of the image frame may be selected in view of a distance criteria, which is provided and/or determined to ensure that pixels depicting the same object of the image are not sampled together. The transmitting device can encode the image data and transmit the encoded image data with the error sampling data to the receiving device. A size of the sets of pixels can be determined in view of a quantization parameter associated with a codec of an encoder for the video stream, in some embodiments.

Upon receipt of the encoded image data and the error sampling data, the receiving device can decode the encoded image data and extract characteristics of the one or more pixels located at the regions sampled by the transmitting device. The receiving device can compare the extracted characteristics for a decoded image frame to the characteristics of the error sampling data received with the encoded image data and determine whether there is a difference (or a significant difference) between the characteristics, thus indicating an error (e.g., distortion) between the image at the transmitting device and the decoded image at the receiving device. If a difference between the extracted characteristics of the decoded image frame and the characteristics of the error sampling data exceeds a difference threshold, the receiving device can transmit a notification of the error to the platform and/or a client device of an engineer or operator of a platform. The notification can include a score or a rating indicating whether the difference exceeds or falls below the threshold, in some embodiments. The score or rating can signal (e.g., to the platform) that the image data that is decoded at the receiving device is different from the image data that is captured and/or encoded at the transmitting device. In additional or alternative embodiments, the notification can include information associated with the receiving device (e.g., a current version of video streaming software operating on the receiving device, etc.).

In some embodiments, the platform can use the information of the notification to determine a source of the error(s). For example, if the error sampling data obtained by the transmitting device corresponds to (e.g., matches) the error sampling data obtained by the receiving device, the platform can determine that no error has occurred during or after the encoding of the audiovisual data at the transmitting client device. If the error sampling data of the transmitting device does not correspond to the error sampling data of the receiving device, the platform can determine that an error has occurred during the encoding, the transmission, or the decoding of the audiovisual data. If the error sampling data of the transmitting device corresponds to the error sampling data of the receiving device, but a distortion is reported to the platform (e.g., by a virtual meeting participant), the platform can determine that an error has occurred prior to the encoding of the audiovisual data. In additional or alternative embodiments, the platform can use the information to identify and/or perform operations to correct such error(s) and/or track whether such errors are occurring elsewhere in the system (e.g., at client devices that are running the current version of the video streaming software), as described herein.

Aspects of the present disclosure address the above described deficiencies by providing techniques for obtaining metrics that signal distortion or other quality issues of image data streamed to a receiving client device, while minimizing the amount of computing resources (e.g., network bandwidth, processing cycles, etc.) consumed to obtain such metrics and/or detect such quality issues. The error sampling data collected for the image data prior to encoding at the transmitting client device can be indicative of a state of the image data (e.g., an error state of the data) prior to transmission to the receiving client device. By comparing the error sampling data collected at the transmitting client device to the error sampling data obtained based on the decoded image data at the receiving device, the system can detect when there is a distortion or other quality issues that have arisen during the encoding, transmission, and/or decoding of the image data. As the error sampling data is collected for a pixels (or portions of pixels) of the image data (e.g., rather than for an entire image frame), the size of the error sampling data can be small and fewer computing resources are consumed to obtain the error sampling data (e.g., than are consumed to calculate PSNR, SSIM, VMAF, etc.). As fewer computing resources are consumed to obtain the error sampling data, fewer overall computing resources are consumed for detecting a quality issue and/or identifying a source of the quality issue, which increases an overall efficiency and efficacy and decreases an overall latency of the system.

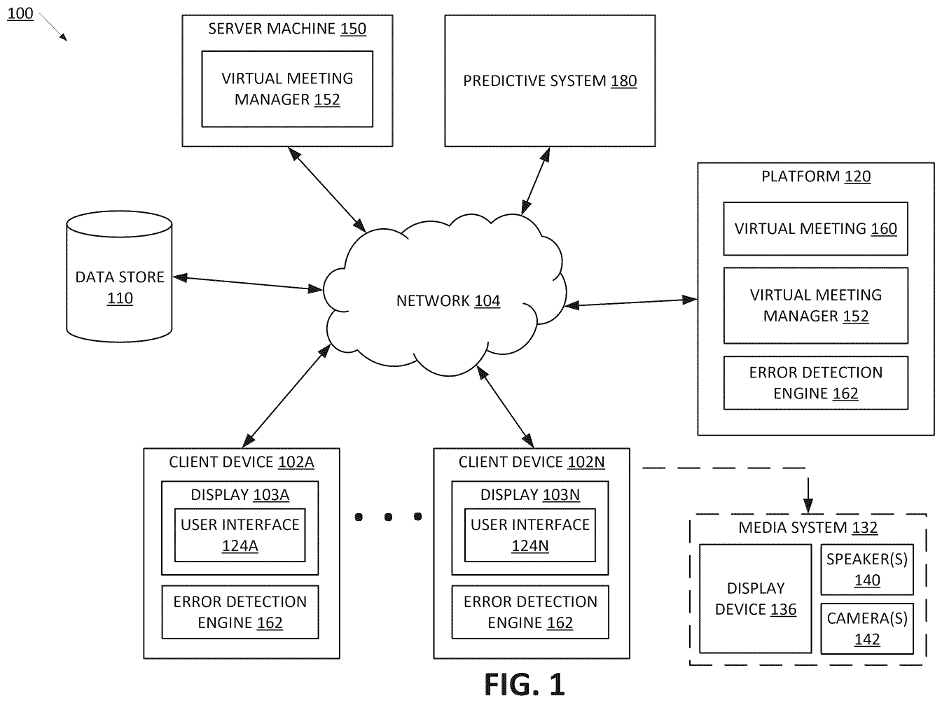

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, a server machine 150, and/or a predictive system 180 each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can enable users of client devices 102A-N to connect with each other via a virtual meeting (e.g., virtual meeting 160). A virtual meeting 160 can be a video-based virtual meeting, which includes a meeting during which a client device 102 connected to platform 120 captures and transmits image data (e.g., collected by a camera of a client device 102) and/or audio data (e.g., collected by a microphone of the client device 102) to other client devices 102 connected to platform 120. The image data can, in some embodiments, depict a user or group of users that are participating in the virtual meeting 160. The audio data can include, in some embodiments, an audio recording of audio provided by the user or group of users during the virtual meeting 160. In additional or alternative embodiments, the virtual meeting 160 can be an audio-based virtual meeting, which includes a meeting during which a client device 102 captures and transmits audio data (e.g., without generating and/or transmitting image data) to other client devices 102 connected to platform 120. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” A client device 102 can include an audiovisual component that can generate audio and/or video data (also referred to herein as image data) to be streamed to conference platform 120. In some implementations, the audiovisual component can include one or more devices (e.g., a microphone, etc.) that capture an audio signal representing audio provided by the user. The audiovisual component can generate audio data (e.g., an audio file or audio stream) based on the captured audio signal. In some embodiments, the audiovisual component can additionally or alternatively include one or more devices (e.g., a speaker) that output data to a user associated with a particular client device 102. In some embodiments, the audiovisual component can additionally or alternatively include an image capture device (e.g., a camera) to capture images and generate image data (e.g., a video stream) of the captured images.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be or otherwise include a smart display or a non-smart display (e.g., a display that is not itself configured to connect to platform 120 or other components of system 100 via network 104). Users that are physically present in the conference room or the meeting room can use media system 132 rather than their own client devices 102 to participate in a virtual meeting, which may include other remote participants. For example, participants in the conference room or meeting room that participate in the virtual meeting may control display 136 to share a slide presentation with, or watch a slide presentation of, other participants that are accessing the virtual meeting remotely. Sound and/or camera control can similarly be performed. As described above, a client device 102 connected to a media system 132 can generate audio and video data to be streamed to platform 120 (e.g., using one or more microphones (not shown), speaker(s) 140 and/or camera(s) 142).

Client devices 102A-N can each include a content viewer, in some embodiments. In some implementations, a content viewer can be an application that provides a user interface (UI) (sometimes referred to as a graphical user interface (GUI)) for users to access a virtual meeting 160 hosted by platform 120. The content viewer can be included in a web browser and/or a client application (e.g., a mobile application, a desktop application, etc.). In one or more examples, a user of client device 102A can join and participate in a virtual meeting 160 via UI 124A presented via display 103A via the web browser and/or client application. A user can also present or otherwise share a document to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a virtual meeting manager 152. Virtual meeting manager 152 can be configured to manage a virtual meeting 160 between two or more users of platform 120. In some embodiments, virtual meeting manager 152 can provide UI 124 to each of client devices 102 to enable users to watch and listen to each other during a video conference. Virtual meeting manager 152 can also collect and provide data associated with the virtual meeting 160 to each participant of the virtual meeting 160. For example, virtual meeting manager 152 can provide a summary associated with the virtual meeting 160 to one or more participants of the virtual meeting 160.

As indicated above, audiovisual data signals (e.g., a video or image signal, an audio signal, etc.) can be transmitted between client devices 102 during a virtual meeting 160. For purposes of explanation and illustration, a client device 102 that captures audiovisual data signal for transmission to another client device 102 is referred to as a transmitting device. The client device 102 that receives the audiovisual data signal from the transmitting device is referred to as a receiving device. In some instances, errors can be introduced into the audiovisual data signal(s) prior to, during, or after the transmission between client devices 102. An error, as described herein, can include any type of error that distorts content of the image and/or audio of an audiovisual signal from the original content captured by the audiovisual component of a client device 102. Examples of errors include, but are not limited to, pixelation errors (e.g., errors that cause a receiving device to display a bitmap or section of a bitmap at such a large size that individual pixels of the bitmap are visible), blurred image errors (e.g., errors that cause the image frames presented via the UI of the receiving device to appear blurred), color errors (e.g., errors that cause the image frames presented via the UI of the receiving device 102 to have a different color than the original color of the image captured by the transmitting device 102), and so forth. An error can be introduced during an encoding process (e.g., to encode the audiovisual data signal prior to transmission to the receiving device), a packetization and/or metadata process (e.g., to divide the encoded audiovisual data signal into a series of data packets and/or extract or otherwise obtain metadata for the data packets), a transmission process (e.g., to transmit the data packets and/or the metadata from the transmitting device to the receiving device), a buffering process (e.g., to temporarily store the data packets received by the receiving device at a buffer or other region of memory), a decoding process (e.g., to decode the encoded data packets at the receiving device), and so forth.

In some embodiments, platform 120 can include an error detection engine 162 that is configured to perform one or more operations associated with detecting errors in an audiovisual data stream transmitted between two or more client devices 102. Prior to transmission of an encoded audiovisual data signal from a transmitting device to a receiving device, the error detection engine 162 can obtain error sampling data for the audiovisual data signal. In some embodiments, the error sampling data can be obtained for one or more regions of the image frames captured by the transmitting client device, and can indicate characteristics (e.g., color data, light intensity data, etc.) of one or more pixels at each of the regions. Once the audiovisual data signal is received at the receiving device, the error detection engine 162 can obtain error sampling data for the audiovisual data signal at the receiving device, which indicates characteristics of the one or more pixels of the image frames for presentation to the user associated with the receiving device.

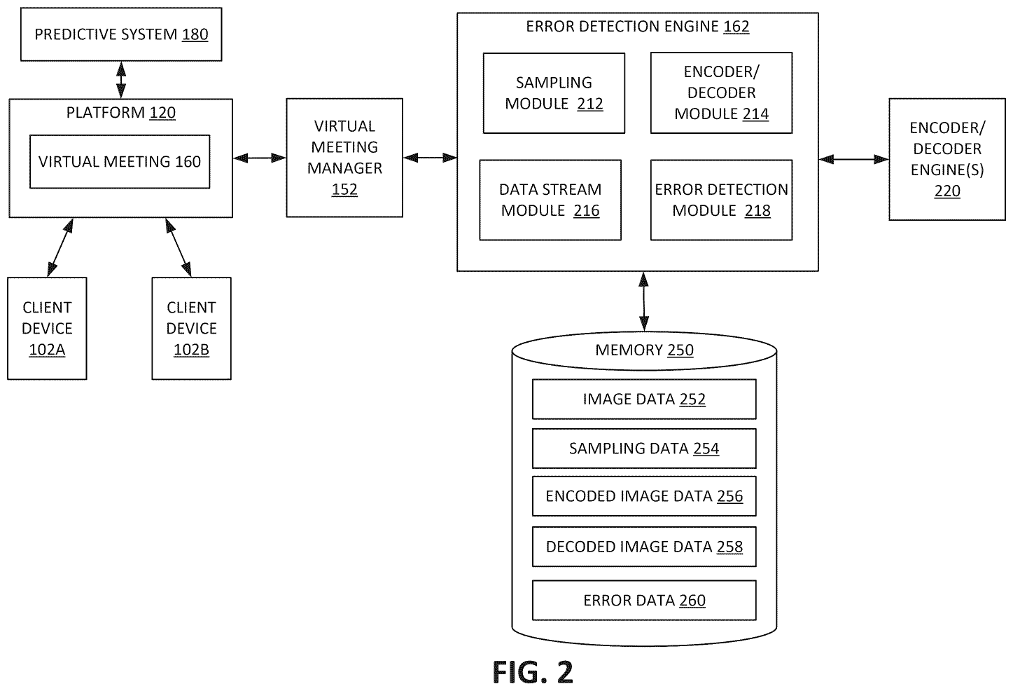

The error detection engine 162 can compare the error sampling data for the image frames captured by the transmitting device to the error sampling data for the image frames at the receiving device to determine whether the characteristics of the pixels of the image frames at the transmitting device correspond to (e.g., match or substantially match) the characteristics of the pixels of the image frames at the receiving device. In some instances, the error detection engine 162 can determine a quality score or metric based on the comparison and can transmit the determined score or metric to a client device 102 associated with a developer or operator of the platform 120. The score or metric can indicate to the developer or operator whether the pixels of the image frame of the audiovisual stream received by the receiving device are distorted from the pixels of the original image frame (e.g., captured by the transmitting device). In some embodiments, the error detection engine 162 can obtain information indicating a state of the transmitting device and/or the receiving device and can include the obtained information with the determined score or metric provided to the client device of the developer or operator. Further details regarding obtaining the error sampling data, determining the score or metric based on the error sampling data, and the state information are provided herein with respect to FIGS. 2-4.

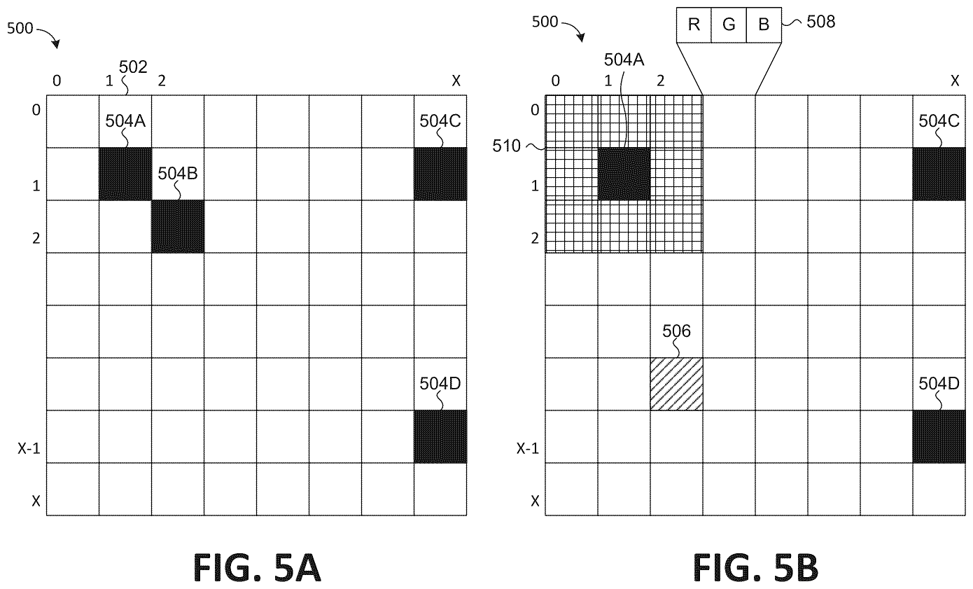

As illustrated in FIG. 1, system 100 can also include a predictive system 180, in some embodiments. Predictive system 180 can implement one or more artificial intelligence (AI) and/or machine learning (ML) techniques for encoding audiovisual data, decoding audiovisual data, and/or detecting errors in audiovisual data transmitted between two or more client devices 102. In some embodiments, predictive system 180 can train an AI model (e.g., a machine learning model) to encode and/or decode audiovisual data, or predict optimized parameters associated with encoding and/or decoding the audiovisual data. In other or similar embodiments, predictive system 180 can train an AI model to predict an error score indicating whether an error is present and/or a degree of an error present in image frames of a receiving device, as described herein. Further details regarding predictive system 180 and the trained AI model are provided herein with respect to FIG. 5.

It should be noted that although FIG. 1 illustrates error detection engine 162 as part of platform 120, in additional or alternative embodiments, one or more portions or components of error detection engine 162 can reside and/or be executed at client device(s) 102, as illustrated by FIG. 1. In other or similar embodiments, error detection engine 162 can reside on one or more server machines that are remote from platform 120. In additional or alternative embodiments, virtual meeting manager 152 can reside on one or more server machines that are remote from platform 120 (e.g., server machine 150). It should be noted that in some other implementations, the functions of platform 120, server machine 150 and/or predictive system 180 can be provided by more or a fewer number of machines. For example, in some implementations, components and/or modules of platform 120, server machine 150 and/or predictive system 180 may be integrated into a single machine, while in other implementations components and/or modules of any of platform 120, server machine 150 and/or predictive system 180 may be integrated into multiple machines. In addition, in some implementations, components and/or modules of server machine 150 and/or predictive system 180 may be integrated into platform 120.

In general, functions described in implementations as being performed platform 120, server machine 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing a conference call hosted by platform 120. Implementations of the disclosure are not limited to conference platforms and can be extended to any type of virtual meeting and/or any type of content streamed to a client device 102. Further implementations of the present disclosure are not limited to image data collected during a virtual meeting and can be applied to other types of image data (e.g., image data generated and provided to a content sharing platform by a client device 102).

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120 and an example error detection engine 162, in accordance with implementations of the present disclosure. As discussed above, platform 120 may be a virtual meeting platform that enables users of client devices 102 to connect with each other via a virtual meeting 160. During a virtual meeting 160, a client device 102 of a virtual meeting participant can generate or otherwise obtain audiovisual data, which can include image data (e.g., image frames) depicting the virtual meeting participant and/or audio data indicating audio provided by the virtual meeting participant (or audio captured for an environment including the virtual meeting participant. In an illustrative example, a first client device 102A associated with a first participant of a virtual meeting 160 can obtain audiovisual data and transmit the audiovisual data for presentation via a second client device 102B to a second participant of the virtual meeting 160. The first client device 102A can transmit the audiovisual data directly to the second client device 102B, in some instances. In other instances, the first client device 102A can transmit the audiovisual data to platform 120 and platform 120 can transmit the received audiovisual data to the second client device 102B. The first client device 102A, which generates and transmits the audiovisual data, is referred to herein as transmitting client device 102A, or simply transmitting device 102A. The second client device 102B, which receives the audiovisual data, is referred to herein as receiving client device 102B, or simply receiving device 102B. It should be noted that “transmitting device” and “receiving device” are used for the purpose of explanation and illustration only. Although a receiving device 102B can receive audiovisual data associated with a first virtual meeting participant from a transmitting device 102A, an audiovisual component of the receiving device 102B can also (e.g., simultaneously) generate audiovisual data associated with a second virtual meeting participant and transmit the generated audiovisual data to the transmitting device 102A (e.g., in accordance with virtual meeting 160).

As described above, virtual meeting manager 152 can be configured to manage a virtual meeting 160 between two or more users of a platform. For example, virtual meeting manager 152 can provide a UI 124 to each client device 102 connected to the platform to enable the virtual meeting participants to watch and listen to each other during the virtual meeting 160. In some embodiments, one or more portions of virtual meeting manager 152 can reside at or be executed via client device(s) 102.

As also described above, error detection engine 162 perform one or more operations associated with detecting errors in an audiovisual data stream transmitted between two or more client devices 102 (e.g., during virtual meeting 160). As illustrated in FIG. 2, error detection engine 162 can include a sampling module 212, an encoder/decoder module 214, a data stream module 216, and/or an error detection module 218. Details regarding error detection engine 162 and the operations associated with detecting errors in the audiovisual data stream are provided with respect to FIGS. 2-4. As described with respect to FIG. 1, one or more components or modules of error detection engine 162 can reside at platform 120 (or one or more server machines of platform 120), in some embodiments. In other or similar embodiments, one or more components or modules of error detection engine 162 can reside at client device(s) 102).

As illustrated in FIG. 2, platform 120, virtual meeting manager 152, and/or error detection engine 162 can each be connected to memory 250. In some embodiments, memory 250 can include one or more portions of data store 110. In other or similar embodiments, memory 250 can include any memory of system 100, a component or device of system 100, and/or a component or device connected to system 100 (e.g., via network 104 and/or another network). Memory 250 can include one or more portions of memory (e.g., local memory) of client device(s) 102, in some embodiments.

As will be seen below, some embodiments are described with respect to detecting errors based on characteristics of image frame pixels of image data. However, embodiments of the present disclosure can be applied to any type of data included in an audiovisual data stream. For example, embodiments of the present disclosure can be applied to detecting errors based on characteristics of audio segments of audio data of an audiovisual data stream. Further, embodiments of the present disclosure can be applied to detecting errors of any audiovisual data transmitted to, from, or between client device(s) 102 of a system. Although embodiments are described with respect to audiovisual data for a virtual meeting 160, such embodiments can be applied to other applications or in other contexts.

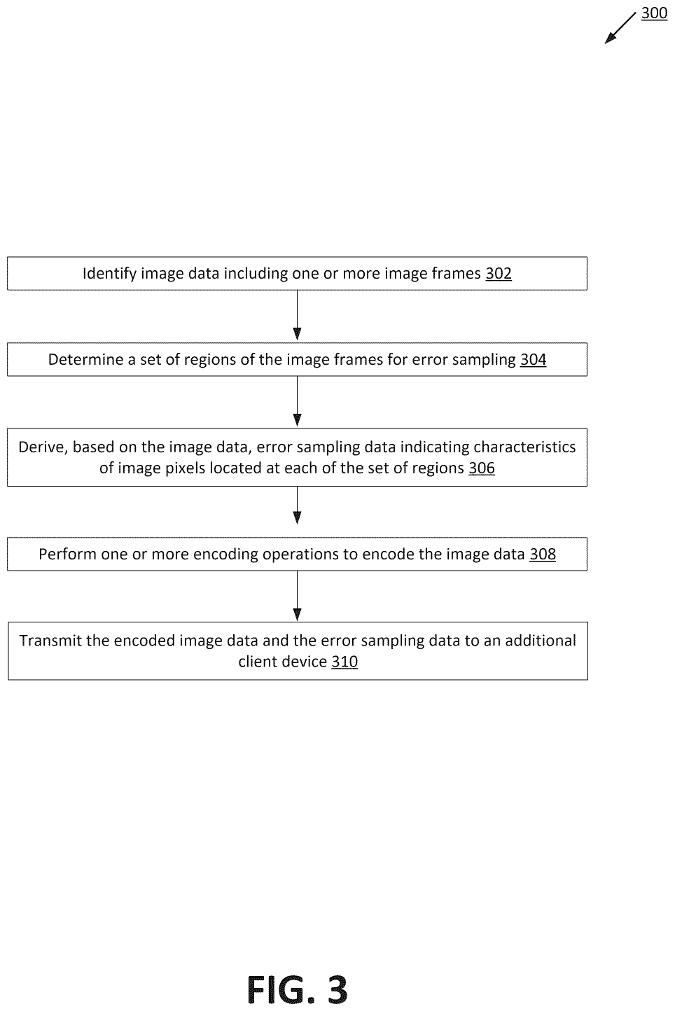

FIG. 3 depicts a flow diagram of an example method 300 for error state validation of a media transmission system, in accordance with implementations of the present disclosure. Method 300 can be performed by processing logic that may include hardware (circuitry, dedicated logic, etc.), software (e.g., instructions run on a processing device), or a combination thereof. In one implementation, some or all the operations of method 300 can be performed by one or more components of system 100 of FIG. 1 and/or one or more components of FIG. 2. In some embodiments, one or more operations of method 300 may be performed by one or more components of error detection engine 162, as described herein. In some embodiments, one or more operations of method 300 may be performed by one or more components of error detection engine 162 residing or otherwise associated with client device 102A, as described herein.

At block 302, processing logic identifies image data including one or more image frames. As described above, an audiovisual component of a transmitting client device 102A can generate or otherwise collect audiovisual data (e.g., image data, audio data, etc.) associated with a participant of a virtual meeting 160. The transmitting client device 102A can transmit the audiovisual data for presentation to another virtual meeting participant via a receiving client device 102B. In some embodiments, error detection engine 162 (e.g., residing at the transmitting client device 102A and/or at the platform 120) can obtain image data 252 based on the generated audiovisual data. The obtained image data 252 can depict the virtual meeting participant associated with client device 102A in an environment, in some embodiments. The image data 252 can include one or more image frames. The sequence of the image frames corresponds to a video signal collected by the audiovisual component (e.g., during the virtual meeting 160).

Referring back to FIG. 3, at block 304, processing logic determines a set of regions of the image frames for error sampling. Error sampling refers to a process of obtaining characteristics of one or more pixels of the image frames of image data 252. The characteristics of a pixel can include color data and/or light intensity data for the pixel and/or one or more subpixels of the pixel. Further details regarding the error sampling data for a pixel are provided below. For example and illustration only, some embodiments below describe obtaining error sampling data for a single image frame of the image data 252. However, such embodiments can be applied to obtaining error sampling data for multiple frames of the image data, as described herein.

It should be noted that in some embodiments, error sampling, as described herein, may be performed for each image frame of image data 252. In other or similar embodiments, error sampling may be performed for a portion of image frames of image data 252. For example, as described above, image data 252 can correspond to a video stream transmitted between client device 102A and 102B. In such example, error sampling may be performed for one or more image frames of the video stream generated or otherwise obtained at a particular rate (e.g., one image frame every second, etc.).

Sampling module 212 of error detection engine 162 can determine the regions of the image frames for error sampling. In some embodiments, sampling module 212 can determine the regions for error sampling by randomly (or quasi randomly) selecting two or more random pixels of the image frame. For example, sampling module 212 can obtain one or more outputs of a random image pixel selector function, which indicate one or more randomly selected image pixels of the image frame. Sampling module 212 can provide the image frame as an input to the function, in some embodiments. In other or similar embodiments, sampling module 212 can provide different or additional data as input to the function. For example, sampling module 212 can provide, as an input to the function, information corresponding to a number of pixels of the image frame, a pixel map of the image frame, such as pixel map 500 of FIG. 5A, a number of pixels to be randomly selected, and so forth.

In some embodiments, the one or more outputs of the function can include coordinates indicating a location of the randomly selected image pixels. For example, FIG. 5A illustrates an example pixel map of an image frame, in accordance with embodiments of the present disclosure. As illustrated in FIG. 5A, each pixel 502 of the pixel map 500 can be arranged in a grid-format, where each pixel 502 is associated with a respective vertical coordinate and a respective horizontal coordinate. For example, the pixel 502 at the top left of the pixel map 500 can have a coordinate of (0, 0), while the pixel 502 at the bottom right of the pixel map 500 can have a coordinate of (X, X). The output(s) of the function can include, for each randomly selected pixel, a vertical coordinate (e.g., indicating a column of the pixel map 500 that includes the pixel) and a horizontal coordinate (e.g., indicating a row of the pixel map 500 that includes the pixel). In an illustrative example, the output(s) of the function can include coordinates for four randomly selected pixels. For instance, selected pixel 504A can have the coordinates of (1, 1), selected pixel 504B can have the coordinates of (2, 2), selected pixel 504C can have the coordinates of (X, 1), and selected pixel 504D can have the coordinates of (X, X−1).

In some embodiments, sampling module 212 can include the selected pixels 504 and/or the coordinates of the selected pixels 504, as obtained from the output(s) of the random image pixel selector function in the set of regions for error sampling. In other or similar embodiments, sampling module 212 can determine whether the selected image pixels 504 satisfy one or more sampling distance criteria before including the coordinates for the selected image pixels 540 in the set of regions for error sampling. The sampling distance criteria can indicate a threshold distance between pixels selected for error sampling, such that the selected pixels are not too close together. In some embodiments, the sampling criteria can be provided by a developer or operator of platform 120 and/or can be determined based on historical or experimental data for platform 120. The selected pixels 504 can satisfy the distance criteria if a distance between the location of each of the selected pixels 504 meets or exceeds a threshold distance. In accordance with the illustrative example of FIG. 5A, the threshold distance can correspond to a size (e.g., a length, a width, etc.) of three image pixels, such that at least three pixels are between each selected pixel 504. In other or similar embodiments, selected pixels 504 can satisfy the distance criteria if each of the selected pixels 504 depict a different object or a different scene from other selected pixels 504. Sampling module 212 can determine that the one or more sampling distance criteria are satisfied with respect to selected pixels 504A, 504C, and 504D, as there are at least three pixels between each of these pixels (e.g., in the vertical, horizontal, and diagonal direction). However, sampling module 212 can determine that the sampling distance criteria are not satisfied with respect to selected pixels 504A and 504B, as the number of pixels between pixels 504A and 504B is less than three.

Upon determining that the sampling distance criteria are not satisfied with respect to one or more selected pixels 504, sampling module 212 can select new pixels 506 for inclusion in the set of regions for error sampling. For example, sampling module 212 can provide one or more inputs to the random image pixel selector function to obtain one or more new selected pixels 504 (e.g., to replace selected pixels 504A or 504B, to replace all of the selected pixels 504). Sampling module 212 can continue to provide inputs to the random image pixel selector function until each of the selected pixels 504 satisfy the one or more pixel distance criteria. In other or similar embodiments, sampling module 212 can identify a non-selected pixel that meets or is outside of threshold distance from selected pixels 504 that do satisfy the pixel distance criteria. For example, upon determining that pixels 504A, 504C, and 504D satisfy the criteria, but pixel 504B does not, sampling module 212 can identify a non-selected pixel to replace selected pixel 504B, where the distance between pixels 504A, 504B, 504C, and 504D satisfy the criteria. As illustrated in FIG. 5B, sampling module 212 can identify selected pixels new pixel 506 as a pixel that satisfies the pixel distance criteria, in accordance with above described embodiments. Upon identifying selected pixels (e.g., pixels 504 and/or pixel 506) that satisfy the one or more panel distance criteria, sampling module 212 can include the pixels and/or the coordinates for such pixels, in the set of regions for error sampling.

In yet other or similar embodiments, sampling module 212 can select new pixels 506 for inclusion of the set of regions by identifying a region of the pixel map that depicts or otherwise corresponds to a different object or scene of the image frame. Sampling module 212 can provide the image frame as an input to an object detection engine that is configured to detect one or more objects depicted in an image. Based on the outputs of the object detection engine, sampling module 212 can determine objects or regions of the image frame that correspond to distinct content and can determine whether two or more selected pixels 504 correspond to the same distinct content. Upon determining that two or more selected pixels 504 correspond to the same distinct content, sampling module 212 can identify one or more non-selected pixels that correspond to different distinct content and can select one of the one or more non-selected pixels for inclusion in the set of regions for error sampling, as described above.

In yet additional or alternative embodiments, sampling module 212 can determine the set of regions for error sampling based on one or more outputs of a quasi-random pixel selector function. For example, the quasi-random pixel selector function can include a Halton sequence function and/or a Van der Corput sequence function, which can take an input indicating a dimension (e.g., of pixel map 500 of an image frame) and provide, as an output, a sequence of quasi-random values that are evenly distributed (or are approximately evenly distributed) across the dimension. In some embodiments, the input to the quasi-random pixel selector function can include the height and width of the pixel map 500 and/or the image frame of image data 252. The output of the quasi-random pixel selector function can indicate locations of the pixel map 500 and/or the image frame of the image data 252 that are quasi-randomly selected, per the functionality of the function. Sampling module 212 can include the locations of the pixel map 500 and/or the image frame in the set of regions for error sampling, as described above.

Sampling module 212 can determine the set of regions for error sampling according to other techniques, in additional or alternative embodiments. For example, rather than obtaining a random, or quasi-random, selection of pixels for the entire pixel map 500 of the image frame, sampling module 212 can obtain a random, or quasi-random, selection of pixels for particular regions of the pixel map 500 (e.g., a center region of the pixel map 500, one or more edges of the pixel map 500, etc.). In an illustrative example a developer or operator of platform 120 can provide or otherwise define one or more weighting or bias criteria that indicate regions of an image frame for which pixels are to be selected. In some embodiments, sampling module 212 can identify the region of the pixel map 500 that correspond to the regions indicated by the weighting or bias criteria and can provide information pertaining to the identified region as an input to the random, or quasi-random, image pixel selector function. The output of the function(s) can indicate randomly, or quasi-randomly, selected pixels within the identified region, as described above. In other or similar embodiments, sampling module 212 can provide the weighting or bias criteria as an input to the function(s), with the information pertaining to the entire pixel map 500, and obtain the selected pixels within the region indicated by the criteria based on one or more output(s) of the function.

Referring back to FIG. 3, at block 306, processing logic derives, based on the image data, error sampling data indicating characteristics of one or more image pixels located at each of the determined regions. In some embodiments, the characteristics can be obtained for an entire image pixel and/or for a subpixel of an image pixel. The characteristics of the image pixels can include color data and/or light intensity data of a respective image pixel and/or a subpixel of the image pixel. In some instances, a pixel (e.g., a color pixel) of an image frame can include one or more subpixels that, together, provide the color signal of the pixel. For example, a red, green, blue pixel (RGB) can include a red subpixel, a green subpixel, and a blue subpixel. Each subpixel of an image can correspond to one or more respective subpixels of a display (e.g., of UI 124) and, when the subpixels of the display are illuminated according to the subpixels of the image, the display presents the image according to the color and/or intensity of the subpixels. FIG. 5B illustrates example subpixels 508 for the image frame corresponding to pixel map 500. As illustrated in FIG. 5B, each pixel 502 can include or be made up of a red subpixel 508, a green subpixel, and a blue subpixel, which correspond to respective subpixels of a display of UI 124. The subpixels for an image may correspond to other types of pixels of the display that will present the image. For example, the subpixels for an image can correspond to hexadecimal subpixels, cyan magenta, yellow, key/black (CYMK) subpixels, grayscale subpixels, and so forth.

Sampling module 212 can derive the error sampling data by determining, based on the features of the image frame generated by client device 102A, the color and/or intensity of light associated with the portion of the image depicted by a respective image pixel 502 indicated by the determined set of regions for error sampling. In accordance with the illustrative example of FIG. 5B, sampling module 212 can identify a region of the image frame generated by client device 102A that corresponds to selected pixel 504A and extracts, from the identified region of the image frame, the color associated with the identified region and/or the intensity of light associated with the identified region. In some embodiments, sampling module 212 can determine a value for a parameter that represents the determined color and/or light intensity for the pixel. Such parameter is referred to as an image characteristic value. Sampling module 212 can determine the image characteristic values for each pixel indicated by the determined set of regions and can store the determined values at memory 250 as sampling data 254.

In some embodiments, sampling module 212 can determine the features of pixels that surround the selected pixel 504 and can use the determined features of the surrounding pixels to determine and/or update the value of the image characteristic for the region associated with the pixel 504. In an illustrative example, sampling module 212 can determine an image characteristic value that represents the color and/or light intensity of the image depicted by a set of pixels surrounding the selected pixel. Such pixels are illustrated as surrounding pixels 510 of FIG. 5B. The size and/or dimension of the set of surrounding pixels 510 can be defined and/or provided by a developer or operator of platform 120, in some embodiments. In other or similar embodiments, the size and/or dimension of the set of surrounding pixels 510 can be determined based on experimental and/or historical data associated with platform 120. Upon obtaining the value of the image characteristic at each of the surrounding pixels 510, sampling module 212 can provide the value of the image characteristic for the selected pixel 504 and each of the surrounding pixels 510 as an input to an aggregator function, which is configured to calculate an aggregated value for the region associated with the selected pixel 504. In some embodiments, the aggregator function can include an averaging function that calculates an average of the values for the region. The aggregator function can include other types of functions, as described herein. Upon obtaining the aggregated image characteristic value for the region, sampling module 212 can store the obtained aggregated value at memory 250 as sampling data 254. For purposes of explanation only, “image characteristic” is described with respect to below embodiments. However, such embodiments can be applied to image characteristics determined for a single selected pixel 504 and/or aggregated image characteristic values determined for a selected pixel and a set of surrounding pixels 510, as described above.

In some embodiments, sampling module 212 can determine which pixels surrounding the selected pixel 504 to select for error sampling based on image filtering sample data. An image filter refers to a technique used to process or transform an image by applying a function to pixels of the image. Such function often involves a neighborhood of pixels around a target pixels. Image filtering sample data can indicate a size of the set of pixels (e.g., including the target pixels and the neighborhood of pixels) that are to be subject to the function. In one or more embodiments, the size of the set of pixels can be determined and/or defined based on a quantization parameter value for a codec of an encoder/decoder of client device(s) 102. A quantization parameter value can indicate an amount or a degree of data that has been truncated or otherwise impacted by lossy compression by the encoder of client device 102, in some embodiments. In some instances, a large quantization parameter value indicates that a large amount or degree of data has been truncated or otherwise impacted by lossy compression, and a small quantization parameter value indicates that a small amount or degree of data has been truncated or otherwise impacted by lossy compression. Sampling module 212 can determine a quantization parameter value for encoder/decoder engine(s) 220 of client device 102A and can determine a size of the set of pixels (e.g., including the selected pixel 504 and surrounding pixels) for error sampling based on the determined quantization parameter value. The size of the set of pixels determined based on a large quantization parameter value can be larger than the size of the set of pixels determined based on a small quantization parameter value, in some embodiments.

In other or similar embodiments, distortion or other such errors may be present in the original image frame generated by client device 102A. Sampling module 212 can determine a baseline distortion level for the image frame and can include a mapping between the baseline distortion level and an image characteristic value calculated for each region of the determined set of regions with sampling data 254. For example, for a respective image frame, sampling module 212 can determine one or more image characteristic values for one or more respective regions of the image frame. Sampling module 212 can generate a distorted version of the image frame, which applies one or more image distortions to the image content (e.g., a blurriness distortion, etc.). Sampling module 212 can determine the image characteristic values for the corresponding respective regions of the distorted image frame and can compare the quantization parameter values of the original image frame to the image characteristic values of the distorted image fame. In some embodiments, sampling module 212 can identify, based on the comparison, an image characteristic value of the original image frame and the image characteristic value of the distorted image frame having the smallest difference. The difference between such identified image characteristic values can represent the baseline distortion level for the image frame. Sampling module 212 can update sampling data 254 to include the mapping between calculated image characteristic values for the original image frame and the determined baseline distortion level for the image frame, in some embodiments. In other or similar embodiments, sampling module 212 can modify the image characteristic value for the original image frame based on the determined baseline distortion level (e.g., by increasing or decreasing the value to reflect the distortion of the original image frame).

As described above, sampling module 212 can determine a respective baseline distortion level for each respective image frame of image data 252. In other or similar embodiments, sampling module 212 can determine the baseline distortion level for one or more initial image frames (e.g., of an image sequence for the video feed collected by client device 102A) and associate the determined baseline level for the initial image frames to the image characteristic values determined for subsequent image frames.

Referring back to FIG. 3, at block 308, processing logic performs one or more encoding operations to encode the image data 252. Image encoding refers to the process of converting a digital image (e.g., an image frame) into a compressed format that is suitable for transmission between client devices 102 (e.g., in view of a bandwidth of network 104 between client devices 102, etc.) and/or between a client device 102 and platform 120. Encoder/decoder module 216 can perform the one or more encoding operations to encode the image data 252, in some embodiments. In other or similar embodiments, encoder/decoder module 214 can provide the image data 252 to an encoder/decoder engine 220, which is configured to encode/decode image data transmitted between two or more client devices 102 and/or between platform 120 and a client device 102. In some embodiments, encoder/decoder engine 220 can reside at a client device 102. For example, encoder/decoder engine 220 can reside at client device 102A. In other or similar embodiments, encoder/decoder engine 220 can reside at a server machine of or associated with platform 120. Client device 102 can transmit the image data 252 to platform 120 and platform 120 can provide the image data 252 to encoder/decoder engine 220 for encoding. In some embodiments, encoder/decoder module 214 can determine one or more encoder parameter settings for image data 252 (e.g., based on one or more characteristics of image data 252, such as content type, degree of motion, etc.) and can provide the one or more encoder parameter settings to encoder/decoder engine(s) 220 (e.g., with image data 252). The image data 252 encoded by encoder/decoder module 214 and/or encoder/decoder engine(s) 220 can be stored at memory 250 as encoded image data 256, in some embodiments.

In yet other or similar embodiments, predictive system 180 can include one or more AI models that are trained to encode image data 252 and/or predict optimized encoding parameters for encoding image data 252. In some embodiments, client device 102A and/or platform 120 can provide the image data 252 to predictive system 180. Predictive system 180 can provide the image data 252 as an input to an AI model that is trained to encode image data 252. Predictive system 180 can obtain the encoded image data 256 based on one or more outputs of the AI model and can provide the encoded image data 256 to client device 102A and/or platform 120, in some embodiments. In other or similar embodiments, predictive system 180 can provide encoded image data 256 directly to client device 102 (e.g., in accordance with operations of block 310, described below).

In other or similar embodiments, client device 102A and/or platform 120 can provide image data 252 and/or an indication of one or more characteristics of image data 252 (e.g., content type, degree of motion, conditions of an environment depicted by the image data 252, etc.) to predictive system 180. Predictive system 180 can provide the image data 252 and/or the characteristics to an AI model that is trained to predict the optimized encoding parameters. Predictive system 180 can obtain the optimized encoding parameters from one or more outputs of the AI model and can provide the optimized encoding parameters to encoder/decoder module 214 and/or encoder/decoder engine(s) 220. Encoder/decoder module 216 and/or encoder/decoder engine(s) 220 can encode the image data 252 using the optimized encoding parameters, as described above.

In some embodiments, an image encoded by encoder/decoder engine(s) 220 may introduce some error into the image that is eventually decoded. This phenomenon is referred to as lossy compression. Due to lossy compression, distortion or other such errors can be introduced into the image, which may be detected by a user viewing the decoded image. As described above, sampling module 212 can perform error sampling for a selected pixel 504 and neighboring pixels based on a quantization parameter for a codec of an encoder and/or decoder (e.g., of encoder/decoder engine(s) 220). By performing the error sampling based on the quantization parameter for the codec of the encoder/decoder engine(s) 220, the error sampling data obtained for the sampled pixels accounts for the distortion introduced into the image by the encoding process.

Referring back to FIG. 3, at block 310, processing logic transmits the encoded image data and the error sampling data to an additional client device (e.g., client device 102B). In some embodiments, data stream module 216 can transmit the encoded image data 256 and the sampling data 254 to client device 102B (e.g., associated with another participant of virtual meeting 160). Data stream module 216 can determine an identifier or an address (e.g., a network address) associated with client device 102B and can transmit the encoded image data 256 and the sampling data 254 to client device 102B based on the determination. In some embodiments, data stream module 216 can establish one or more communication channels between client device 102A and client device 102B. The communication channels can be supported by a networking connection (e.g., of network 104) between client devices 102. Each communication channel is associated with particular data transmitted between the client devices 102. For example, a first communication channel can be associated with transmitting encoded image data 256 between client devices 102A and 102B, while a second communication channel can be associated with transmitting sampling data 254 between client devices 102A and 102B. The communication channels between client devices 102A and 102B may be established or otherwise formed during an initialization process associated with the virtual meeting 160 and/or via the network connection between client devices 102A and 102B. In some embodiments, data stream module 216 can transmit the encoded image data 256 to client device 102B via the first communication channel and the sampling data 254 via the second communication channel.

In some embodiments, data stream module 216 can transmit additional or alternative data to client device 102B. For example, data stream module 216 can transmit an indication of the regions of the image frame determined for error sampling, as described above.

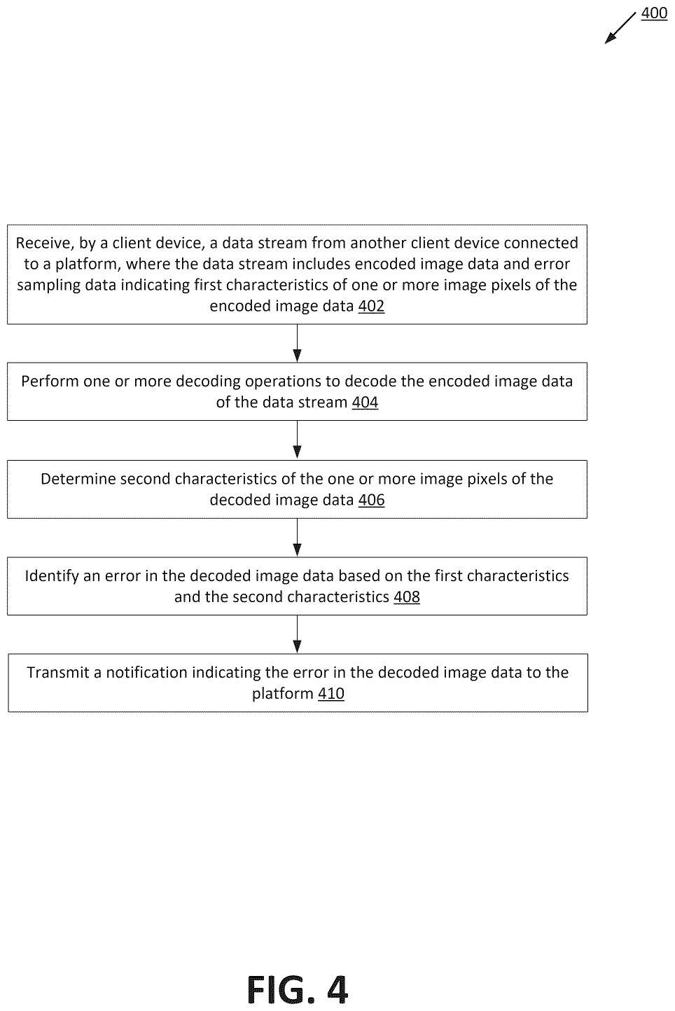

FIG. 4 depicts a flow diagram of another example method 400 for error state validation of a media transmission system, in accordance with implementations of the present disclosure. Method 400 can be performed by processing logic that may include hardware (circuitry, dedicated logic, etc.), software (e.g., instructions run on a processing device), or a combination thereof. In one implementation, some or all the operations of method 400 can be performed by one or more components of system 100 of FIG. 1 and/or one or more components of FIG. 2. In some embodiments, one or more operations of method 400 may be performed by one or more components of error detection engine 162, as described herein. In some embodiments, one or more operations of method 400 may be performed by one or more components of error detection engine 162 residing or otherwise associated with client device 102B, as described herein.

At block 402, processing logic receives, by a client device, a data stream from another client device connected to a platform. The data stream can include encoded image data and error sampling data indicating first characteristics of one or more image pixels of the encoded image data. As described above, data stream module 216 of error detection engine 162 residing at or associated with client device 102A can transmit encoded image data 256 and sampling data 254 to client device 102B (e.g., via one or more communication channels). Data stream module 216 of error detection engine 162 residing at or associated with client device 102B can receive the transmitted encoded image data 256 and the sampling data 254. In some embodiments, data stream module 216 for client device 102B can receive the encoded image data 256 from platform 120 and/or predictive system 180 and can receive the sampling data 254 from client device 102B.

At block 404, processing logic performs one or more decoding operations to decode the encoded image data of the data stream. Encoder/decoder module 214 of error detection engine 162 of client device 102B can perform one or more operations to decode encoded image data 256, in some embodiments. In other or similar embodiments, encoder/decoder module 214 can provide the encoded image data 256 to encoder/decoder engine 220. The decoded image data can be stored at memory 250 as decoded image data 258, in some embodiments. In additional or alternative embodiments, error detection engine 162 can provide the encoded image data 256 to predictive system 180 and predictive system 180 can provide the encoded image data 256 as input to an AI model that is trained to decode encoded image data 256. The AI model can be the same or similar to the model that is trained to encode image data, in some embodiments. Predictive system 180 can provide decoded image data 258 to error detection engine 162, in accordance with embodiments described above.

At block 406, processing logic determines second characteristics of the one or more image pixels of the decoded image. Sampling module 212 of error detection engine 162 can determine the second characteristics of the image pixels of decoded image data 258, in accordance with techniques described above. For example, sampling module 212 can determine the image characteristics for regions of the image frame associated with selected pixels 504 and/or 506, as described above with respect to FIG. 3. In some embodiments, sampling data 254 transmitted to client device 102B can include an indication of the regions of the image frame of image data 252 for which the sampling data 254 was derived. In other or similar embodiments, client device 102A can transmit a notification of the regions of the image frame for which sampling data 254 was derived, as described above. Sampling module 212 can identify regions of the image frame of decoded image data 258 that correspond to the sampled regions of the image frame of image data 252 and can determine the characteristics (e.g., the image characteristic values) at the identified regions, as described above. In accordance with the illustrative example of FIGS. 5A and 5B, sampling module 212 of error detection engine 162 associated with client device 102B can determine characteristics associated with selected pixels 504A, 504B, 504D, and pixel 506, as described above. In some embodiments, sampling module 212 can also determine characteristics associated with surrounding pixels 510 for one or more of pixels 504A, 504B, 504D, and 506.

At block 408, processing logic identifies an error in the decoded image data based on the first characteristics and the second characteristics. In some embodiments, error detection module 218 can compare the sampling data 254 indicating characteristics of pixels of the original image data 254 (e.g., received by client device 102B) to the sampling data 254 indicating characteristics of pixels of the decoded image data 258. Upon determining, based on the comparison, that a difference between the sampling data for the decoded image data 258 and the sampling data for the original image data 252 exceeds a threshold difference, error detection module 218 can detect that an error is present in the decoded image data 258. At block 410, processing logic transmits a notification indicating the error in the decoded image data to the platform. Error detection module 218 can transmit a notification to a client device 102 associated with a developer or operator of the platform 120 indicating the error, in some embodiments. In additional or alternative embodiments, error detection module 218 can transmit information associated with a state (e.g., a hardware state, a software state, etc.) associated with client device 102B. The state information can include a state of one or more processes running via client device 102B during the virtual meeting and/or a state of one or more hardware components supporting the one or more processes. The developer or operator can, in some instances, use the notification and/or the state information to determine whether a defect is present in a component of the transmission pipeline. The information transmitted to the client device 102 of the developer or operator is referred to as error data 260 and can be stored at memory 250, in some embodiments.

In other or similar embodiments, error detection module 218 can transmit the error data 260 to platform 120 and/or virtual meeting manager 152. In some embodiments, virtual meeting manager 152 can update an error tracking data structure (not shown) to include the error data 260. The error tracking data structure can include information associated with one or more errors detected during virtual meetings 160 hosted or supported by platform 120 and/or state information associated with client devices 102 when the error was detected. In some embodiments, virtual meeting manager 152 can track the types of errors that occur during virtual meetings 160 based on the information stored at the data structure and can, in some instances, can provide a notification to a client device 102 of a developer or operator indicating a trend between certain types of information and state information of the client devices 102 when the errors occur.

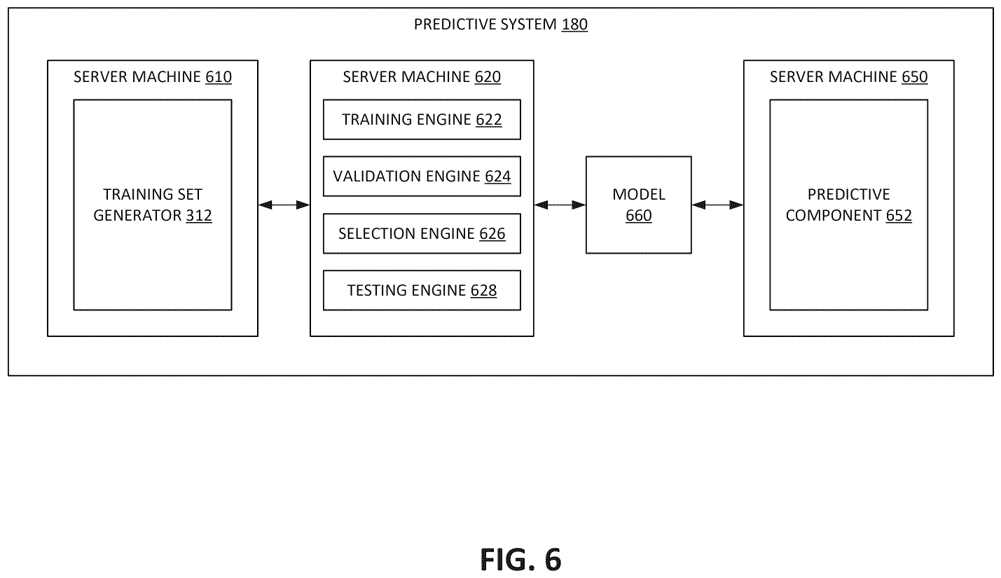

FIG. 6 illustrates an example predictive system 180, in accordance with implementations of the present disclosure. As illustrated in FIG. 6, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train AI model 660. Model 660 can include a machine learning model that is trained to encode/decode data streams and/or predict optimized parameter settings for encoding/decoding data streams.

As mentioned above, training set generator 612 can generate training data for training a model 660. In an illustrative example, training set generator 612 can generate training data to train an encoding/decoding model. In such example, training set generator 612 can initialize a training set T to null (e.g., { }). Training set generator 612 can identify data corresponding to encoded data and an unencoded (or decoded) data. The data can include image data and/or other types of data, in some embodiments. Training set generator 612 can generate an input/output mapping. The mapping can be based on the encoded/unencoded data. Training set generator 612 can add the input/output mapping to the training set T and can determine whether training set T is sufficient for model 660. Training set T can be sufficient for training model 660 if training set T includes a threshold amount of input/output mappings, in some embodiments. In response to determining that training set T is not sufficient for training, training set generator 612 can identify additional encoded/unencoded data and can generate additional input/output mappings based on the additional data. In response to determining that training set T is sufficient for training, training set generator 612 can provide training set T to model 660. In some embodiments, training set generator 312 provides the training set T to training engine 622.

In another illustrative example, training set generator 612 can generate training data to train an AI model to predict optimized parameter settings for encoding/decoding data. In such example, training set generator 612 can initialize a training set T to null (e.g., { }). Training set generator 612 can identify one or more characteristic of data and one or more optimized parameter settings (e.g., as determined by an operator or developer of platform 120, as determined by one or more iterative optimization processes, etc.) previously applied for encoding/decoding the data. The data can include image data, in some instances, and the characteristics can include an indication of a type of content depicted by the image data, a degree of motion of the content, an environment or conditions of an environment for which the image data was captured, a type of device, or components of a device, that captured the image data, and so forth. Training set generator 612 can generate an input/output mapping. The mapping can be based on the characteristics of the data and the optimized parameter settings used to encode/decode the data. Training set generator 612 can add the input/output mapping to the training set T and can determine whether training set T is sufficient for model 660. Training set T can be sufficient for training model 660 if training set T includes a threshold amount of input/output mappings, in some embodiments. In response to determining that training set T is not sufficient for training, training set generator 612 can identify additional encoded/unencoded data and can generate additional input/output mappings based on the additional data. In response to determining that training set T is sufficient for training, training set generator 612 can provide training set T to model 660. In some embodiments, training set generator 312 provides the training set T to training engine 622.

Training engine 622 can train a machine learning model 660 using the training data (e.g., training set T) from training set generator 612. The machine learning model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the machine learning model 660 that captures these patterns. The machine learning model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 612 hosted by server machine 610.

Validation engine 624 may be capable of validating a trained machine learning model 660 using a corresponding set of features of a validation set from training set generator 612. The validation engine 624 may determine an accuracy of each of the trained machine learning models 660 based on the corresponding sets of features of the validation set. The validation engine 624 may discard a trained machine learning model 660 that has an accuracy that does not meet a threshold accuracy. In some embodiments, the selection engine 626 may be capable of selecting a trained machine learning model 660 that has an accuracy that meets a threshold accuracy. In some embodiments, the selection engine 626 may be capable of selecting the trained machine learning model 660 that has the highest accuracy of the trained machine learning models 660.

The testing engine 686 may be capable of testing a trained machine learning model 660 using a corresponding set of features of a testing set from training set generator 612. For example, a first trained machine learning model 660 that was trained using a first set of features of the training set may be tested using the first set of features of the testing set. The testing engine 628 may determine a trained machine learning model 660 that has the highest accuracy of all of the trained machine learning models based on the testing sets.

Predictive component 352 of server machine 350 may be configured to feed data as input to model 660 and obtain one or more outputs. In accordance with previously described embodiments, predictive component 652 can feed image data 252 and/or characteristics determined for image data 252 as input to model 660. In some embodiments, predictive component 652 can obtain encoded image data 256 as an output of model 660. In other or similar embodiments, predictive component 652 can obtain optimized parameter settings for encoding/decoding image data 252 as an output of model 660.

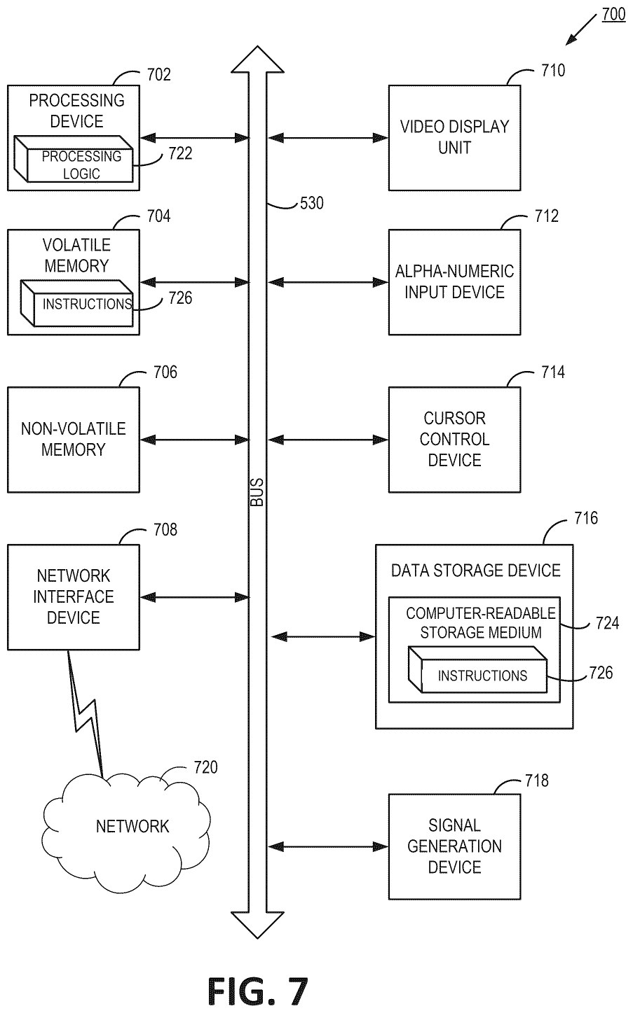

FIG. 7 is a block diagram illustrating an exemplary computer system 700, in accordance with implementations of the present disclosure. The computer system 700 can correspond to platform 120, client devices 102A-N, and/or predictive system 180 described herein and with respect to FIGS. 1-6. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying, by a client device, image data comprising one or more image frames;
determining, by the client device, a plurality of regions of the one or more image frames for error sampling;
deriving, by the client device and based on the image data, error sampling data indicating characteristics of one or more image pixels located at each of the plurality of regions;
performing, by the client device, one or more encoding operations to encode the image data; and
transmitting, by the client device, the encoded image data and the error sampling data to an additional client device.

2. The method of claim 1, wherein determining the plurality of regions for error sampling comprises:
obtaining one or more outputs of a random image pixel selector function, the one or more outputs comprising a plurality of randomly selected image pixels of the one or more image frames;
identifying, for each of the plurality of randomly selected image pixels, a respective region of the one or more image frames that comprises the respective image pixel; and
determining whether a distance between the respective region of the one or more image frames satisfies one or more sampling distance criteria with respect to another region of the plurality of regions.

3. The method of claim 2, wherein determining whether the distance between the respective region of the one or more image frames satisfies one or more sampling distance criteria with respect to another region of the plurality of regions comprises:
determining whether a distance between the respective region and another region of the plurality of regions exceeds a threshold distance, or
determining that the one or more image pixels located at the respective region depicts at least one of a different object or a different scene from the at least one of the object or the scene depicted by the one or more image pixels located at the other region.

4. The method of claim 1, wherein the characteristics of the one or more image pixels located at each of the plurality of regions comprises at least one of color data or light intensity data for a portion of an image depicted by the one or more image pixels.

5. The method of claim 4, wherein extracting the error sampling data comprises:
determining the at least one of the color data or the light intensity data for a subpixel of each of the one or more image pixels located at a respective region of the plurality of regions.

6. The method of claim 1, wherein the encoded image data is transmitted to the additional client device via a first data channel and the error sampling data is transmitted to the additional client device via a second data channel.

7. The method of claim 1, further comprising:
transmitting, to the additional client device, an indication of each of the plurality of regions of the one or more image frames comprising image pixels for which error sampling data was extracted.

8. The method of claim 1, wherein the one or more image frames depict a participant of a virtual meeting in an environment, and wherein the encoded image data and the error sampling data are transmitted to the additional client device during the virtual meeting.

9. The method of claim 1, wherein the derived error sampling data further indicates characteristics of a set of image pixels surrounding each respective region of the plurality of regions, wherein the set of image pixels surrounding each respective region of the plurality of regions has at least one of a fixed size or a fixed dimension.

10. A system comprising:
a memory; and
a set of one or more processing devices coupled to the memory, wherein the set of one or more processing devices is to perform operations comprising:
receiving, by a client device connected to a platform, a data stream from another client device connected to the platform, the data stream comprising encoded image data associated with one or more image frames and error sampling data indicating first characteristics of one or more image pixels located at each of a plurality of regions of the one or more image frames;
performing, by the client device, one or more decoding operations to decode the encoded image data;
determining, by the client device, second characteristics of the one or more image pixels located at each of the plurality of regions based on the decoded image data;
identifying, by the client device and based on the first characteristics and the second characteristics of the one or more image pixels, an indication of an error in the decoded image data; and
transmitting, by the client device, a notification indicating the error in the decoded image data to the platform.

11. The system of claim 10, wherein the characteristics of one or more image pixels located at each of a plurality of regions of the one or more image frames comprises at least one of color data or light intensity data for a portion of an image depicted by the one or more image pixels.

12. The system of claim 11, wherein determining the second characteristics of the one or more image pixels located at each of the plurality of regions based on the decoded image data comprises:
determining the at least one of the color data or the light intensity data for a subpixel of each of the one or more image pixels located at a respective region of the plurality of regions of the decoded image data.

13. The system of claim 10, wherein a first portion of the data stream comprising the encoded image data is received via a first channel and a second portion of the data stream comprising the error sampling data is received via a second channel.

14. The system of claim 10, wherein the operations further comprise:
receiving, from an additional client device that transmitted the data stream, an indication of each of the plurality of regions of the one or more image frames comprising image pixels for which error sampling data was extracted.

15. The system of claim 10, wherein the one or more image frames depict a participant of a virtual meeting in an environment, and wherein the data stream is received during the virtual meeting.

16. The system of claim 10, wherein a distance between each of the plurality of regions satisfies one or more sampling distance criteria.

17. A non-transitory computer readable storage medium comprising instructions for a server that, when executed by a processing device, cause the processing device to perform operations comprising:
identifying, by a client device, image data comprising one or more image frames;
determining, by the client device, a plurality of regions of the one or more image frames for error sampling;
deriving, by the client device and based on the image data, error sampling data indicating characteristics of one or more image pixels located at each of the plurality of regions;
performing, by the client device, one or more encoding operations to encode the image data; and
transmitting, by the client device, the encoded image data and the error sampling data to an additional client device.

18. The non-transitory computer readable storage medium of claim 17, wherein determining the plurality of regions for error sampling comprises:
obtaining one or more outputs of a random image pixel selector function, the one or more outputs comprising a plurality of randomly selected image pixels of the one or more image frames;
identifying, for each of the plurality of randomly selected image pixels, a respective region of the one or more image frames that comprises the respective image pixel; and
determining whether a distance between the respective region of the one or more image frames satisfies one or more sampling distance criteria with respect to another region of the plurality of regions.

19. The non-transitory computer readable storage medium of claim 18, wherein determining whether the distance between the respective region of the one or more image frames satisfies one or more sampling distance criteria with respect to another region of the plurality of regions comprises:
determining whether a distance between the respective region and another region of the plurality of regions exceeds a threshold distance, or
determining that the one or more image pixels located at the respective region depicts at least one of a different object or a different scene from the at least one of the object or the scene depicted by the one or more image pixels located at the other region.

20. The non-transitory computer readable storage medium of claim 17, wherein the characteristics of the one or more image pixels located at each of the plurality of regions comprises at least one of color data or light intensity data for a portion of an image depicted by the one or more image pixels.
